(19) United States
(12) Patent Application Publication
(10) Pub. No.: US 2015/0358644 A1
(43) Pub. Date: Dec. 10, 2015

(54) VIDEO ENCODING APPARATUS AND METHOD, VIDEO DECODING APPARATUS AND METHOD, AND PROGRAMS THEREFOR

(71) Applicant: NIPPON TELEGRAPH AND TELEPHONE CORPORATION, Chiyoda-ku, Tokyo (JP)

(72) Inventors: Shiori Sugimoto, Yokosuka-shi (JP); Shinya Shimizu, Yokosuka-shi (JP); Hideaki Kimata, Yokosuka-shi (JP); Akira Kojima, Yokosuka-shi (JP)

(73) Assignee: NIPPON TELEGRAPH AND TELEPHONE CORPORATION, Tokyo (JP)

(21) Appl. No.: 14/654,976

(22) PCT Filed: Dec. 25, 2013
(86) PCT No.: PCT/JP2013/084689

§ 371 Date: Jun. 23, 2015

(30) Foreign Application Priority Data
Dec. 28, 2012 (JP) 2012-287927

(51) Int. Cl. H04N 19/65; H04N 19/182; H04N 19/44; H04N 19/17; H04N 19/577

(52) U.S. Cl. CPC H04N 19/65; H04N 19/17; H04N 19/577; H04N 19/44; H04N 19/182

(57) ABSTRACT

A video encoding apparatus divides each frame which forms an encoding target video into a plurality of processing regions, each processing region being subjected to predictive encoding, where a basic reference region associated with each processing region as an encoding target image is set. A first reference prediction region and a second reference prediction region, which are reference regions associated with the basic reference region, are set. Based on a first reference predicted image and a second reference predicted image which correspond to the reference prediction regions, weighting coefficients assigned to individual small regions are set. A first prediction region and a second prediction region, which are reference regions for the encoding target image, are set. A predicted image is generated based on the weighting coefficients, and a first primary-predicted image and a second primary-predicted image which are obtained based on the first and second prediction regions.

### TECHNICAL FIELD

The present invention relates to a video encoding apparatus, a video decoding apparatus, a video encoding method, a video decoding method, a video encoding program, and a video decoding program, which utilize bi-predictive encoding.

Priority is claimed on Japanese Patent Application No. 2012-287927, filed Dec. 28, 2012, the contents of which are incorporated herein by reference.

### BACKGROUND ART

In general video encoding, spatial and temporal continuity of each object is utilized to divide each video frame into unit blocks to be processed. A video signal of each block is spatial or temporal predicted, and prediction information, that indicates the utilized prediction method, and a prediction residual are encoded, which considerably improves the encoding efficiency in comparison with a case of encoding the video signal itself.

Additionally, general two-dimensional video encoding employs intra prediction for predicting a target image to be encoded (encoding target image) with reference to a previously-encoded block in the same frame, and (ii) inter prediction for predicting an encoding target image based on, for example, motion search with reference to another frame which was previously decoded.

In various video compression standards including MPEG-1, MPEG-4, and MPEG-2 (MPEG: Moving Picture Experts Group), the encoding or decoding order of images is not the same as the order of reproducing them. Therefore, it is possible to utilize in the inter prediction, not only forward prediction with reference to a temporally prior frame, but also backward prediction with reference to a temporally posterior frame or bi-prediction which mixes the results of prediction utilizing two or more frames.

According to the bi-prediction, it is possible to reduce the prediction error due to rotation between images, variation in luminance, noise, or the like. The bi-prediction is explained in detail in Non-Patent Document 1.

The bi-prediction can be used in scalable video coding to encode images which have different spatial resolutions, and also multi-view video coding to encode multi-view video.

In the scalable coding, it is possible to mix the inter prediction with inter-layer prediction which predicts a high-resolution layer by utilizing a decoded image of a lower resolution layer.

In addition, in multi-view video coding, it is possible to mix the inter prediction with inter-view prediction which predicts the viewpoint of an encoding target by utilizing a decoded image having a different viewpoint.

The scalable video coding is explained in detail in Non-Patent Document 2, and the multi-view video coding is explained in detail in Non-Patent Document 3.

Additionally, as a prediction method that can be combined with an ordinary prediction method, a kind of residual prediction is utilized in which a prediction residual produced when a picture was encoded is utilized to predict a current encoding target picture. Such a residual prediction is explained in detail in Non-Patent Document 4. This method is a prediction method that utilizes a property that when two pictures which are highly correlated with each other are individually predicted from corresponding reference pictures, the individual prediction residuals thereof are also correlated with each other.

In general residual prediction, a prediction residual obtained when a picture was encoded is subtracted from a prediction residual obtained when a current encoding target picture was predicted utilizing a different reference picture, and the computed difference is encoded.

In the scalable encoding, a prediction residual for a low-resolution layer is subjected to upsampling and the result thereof is subtracted from a prediction residual for a high resolution layer, and thereby it is possible to reduce the amount of code.

In the multi-view video encoding, it is possible to improve the encoding efficiency by subtracting from a prediction residual for the viewpoint of the encoding target, a prediction residual for a different viewpoint.

Below, free viewpoint video encoding will be explained. In the free viewpoint video encoding, a target scene is imaged from a plurality of positions and at a plurality of angles by means of multiple imaging devices so as to obtain ray information about the scene. The ray information is utilized to reproduce ray information pertaining to any viewpoint, and thereby video (images) observed from the relevant viewpoint are generated.

Such ray information for a scene is represented in one of various data forms. One of most popular forms utilizes video and a depth image called a “depth map” for each of frames that form the video (see, for example, Non-Patent Document 5).

In the depth map, distance (i.e., depth) from the relevant camera to each object is described for each pixel, which implements simple representation of three-dimensional information about the object.

When observing a single object from two cameras, the depth value for each pixel of the object is proportional to the reciprocal of disparity (for the relevant pixel) between the cameras. Therefore, the depth map may be called a “disparity map (or disparity image)”. On the other hand, a camera image corresponding to the depth map may be called a “texture”. Since the depth map is represented in a manner such that each pixel of the image has a single value, the depth map can be described as a gray-scale image.

In addition, similar to a video signal, depth map video images (below, “depth map” is applied to either of a simple image and a video image), which are temporally continued depth maps, have spatial and temporal correlation due to the spatial and temporal continuity of each object. Therefore, a video encoding method utilized to encode an ordinary video signal can efficiently encode a depth map by removing spatial and temporal redundancy.

Generally, the texture and the depth map have strong correlation with each other. Therefore, in order to encode both the texture and depth map (as performed in the free viewpoint video encoding), the encoding efficiency can be further improved utilizing such correlation between the texture and depth map.

Non-Patent Document 6 disclose a method of removing redundancy by commonly utilizing prediction information (about block division, motion vectors, and reference frames) to encode both the texture and depth map, and thereby efficient encoding is implemented.

In the present description, an “image” denotes one frame of a video or a static image, and a set of frames (images) is a video.

### PRIOR ART DOCUMENT

### Patent Document

### Non-Patent Document

Non-Patent Document 1: M. Flierl and B. Girod, “Generalized B pictures and the draft H. 264/AVC video-compression standard,” Circuits and Systems for Video Technology, vol. 13, no. 7, pp. 587-597, 2003.
Non-Patent Document 2: H. Schwarz, D. Marpe, and T. Wiegand, “Overview of the scalable video coding extension of the H. 264/AVC standard”, IEEE Transactions on Circuits and Systems for Video Technology, vol. 17, no. 9, pp. 1103-1120, September 2007.
Non-Patent Document 3: M. Flierl and B. Girod, “Multiview video compression”, Signal Processing Magazine, IEEE, November 2007, pp. 66-76, 2007.
Non-Patent Document 4: X. Wang and J. Ridge, “Improved video coding with residual prediction for extended spatial scalability”, Communications, Control and Signal Processing, ISCCSP 2008. 3rd International Symposium, pp. 1041-1046, March 2008.
Non-Patent Document 5: Y. Mori, N. Fukushima, T. Yendo, T. Fujii, and M. Tanimoto, “View generation with 3D warping using depth information for FTV”, Signal Processing, Image Communication, vol. 24, no. 1-2, pp. 65-72, January 2009.
Non-Patent Document 6: I. Daribo, C. Tillier, and B. P. Popescu, “Motion Vector Sharing and Bitrate Allocation for 3D Video-Plus-Depth Coding”, EURASIP Journal on Advances in Signal Processing, vol. 2009, Article ID 258920, 13 pages, 2009.

### DISCLOSURE OF INVENTION

### Problem to be Solved by the Invention

In the conventional bi-prediction, two primary-predicted images generated utilizing two different reference regions are mixed so as to compensate a variation in the luminance between frames and reduce noises. However, in this case, if the predicted images are considerably different from each other for a certain part of the images, the prediction accuracy is degraded. In order to solve such an uneven prediction accuracy, weighting coefficients may be applied to the primary-predicted images in the mixture thereof.

For example, the mixed primary-predicted image Pred is represented by:

Pred=[(P0)(Pred0)]+[(P1)(Pred1)]+D

where P0 and P1 are weighting coefficients, Pred0 and Pred1 are primary-predicted images based on two different reference regions, and D is an offset coefficient.

The weighting coefficients and the offset coefficient may be set for each small region or each pixel, which is more effective than a manner such that each coefficient is a scalar value applied to the entire region. However, encoding of such coefficient (values) so as to be used in a corresponding decoding apparatus causes an increase in the amount of code required for the entire bit stream.

In light of the above circumstances, an object of the present invention is to provide a video encoding apparatus, a video decoding apparatus, a video encoding method, a video decoding method, a video encoding program, and a video decoding program, which can generate a highly accurate predicted image without encoding the coefficients.

### Means for Solving the Problem

In order to achieve the above object, the present invention provides a video encoding apparatus that divides each frame which forms an encoding target video into a plurality of processing regions, each processing region being subjected to predictive encoding, and generates a predicted image by utilizing a basic reference region associated with each processing region as an encoding target image, the apparatus comprising:

a reference prediction region setting device that sets, for the encoding target image, a first reference prediction region and a second reference prediction region, which are reference regions associated with the basic reference region;

a weighting coefficient setting device that sets weighting coefficients assigned to individual small regions based on a first reference predicted image obtained by utilizing the first reference prediction region and a second reference predicted image obtained by utilizing the second reference prediction region;

a prediction region setting device that sets a first prediction region and a second prediction region, which are reference regions for the encoding target image; and

a predicted image generation device that generates, based on the weighting coefficients, the predicted image from a first primary-predicted image obtained by utilizing the first prediction region and a second primary-predicted image obtained by utilizing the second prediction region.

The first reference prediction region and the second reference prediction region may be set based on prediction information utilized when the basic reference region was encoded.

The first prediction region and the second prediction region may be set in a manner such that the first prediction region and the second prediction region have a relationship with the encoding target image, that is equivalent to a relationship which the first reference prediction region and the second reference prediction region have with the basic reference region.

The first reference prediction region and the second reference prediction region may be set in a manner such that the first reference prediction region and the second reference prediction region have a relationship with the basic reference region, that is equivalent to a relationship which the first prediction region and the second prediction region have with the encoding target image.

The present invention also provides a video decoding apparatus that divides each decoding target frame which forms video code data into a plurality of processing regions, each processing region being subjected to decoding, and generates a predicted image by utilizing a basic reference region associated with each processing region as a decoding target image, the apparatus comprising:

a reference prediction region setting device that sets, for the decoding target image, a first reference prediction region and a second reference prediction region, which are reference regions associated with the basic reference region;

a weighting coefficient setting device that sets weighting coefficients assigned to individual small regions based on a first reference predicted image obtained by utilizing the first reference prediction region and a second reference predicted image obtained by utilizing the second reference prediction region;

a prediction region setting device that sets a first prediction region and a second prediction region, which are reference regions for the decoding target image; and

a predicted image generation device that generates, based on the weighting coefficients, the predicted image from a first primary-predicted image obtained by utilizing the first prediction region and a second primary-predicted image obtained by utilizing the second prediction region.

The first reference prediction region and the second reference prediction region may be set based on prediction information utilized when the basic reference region was decoded.

The first prediction region and the second prediction region may be set in a manner such that the first prediction region and the second prediction region have a relationship with the decoding target image, that is equivalent to a relationship which the first reference prediction region and the second reference prediction region have with the basic reference region.

The first reference prediction region and the second reference prediction region may be set in a manner such that the first reference prediction region and the second reference prediction region have a relationship with the basic reference region, that is equivalent to a relationship which the first prediction region and the second prediction region have with the decoding target image.

In a preferable example, the video decoding apparatus further comprises:

a reference prediction residual generation device that generates a first reference prediction residual and a second reference prediction residual by computing:
a difference between a basic reference image set based on the basic reference region and the first reference predicted image obtained by utilizing the first reference prediction region; and
a difference between the basic reference image and the second reference predicted image obtained by utilizing the second reference prediction region,

wherein the weighting coefficient setting device sets the weighting coefficients based on the first reference prediction residual and the second reference prediction residual.

The basic reference region may be set on an image obtained by a camera that differs from a camera by which the decoding target image was obtained.

When a decoding target of the video code data is a depth video, the basic reference region may be set on an image of a camera video that corresponds to the depth video.

The first reference prediction region and the second reference prediction region may be set by utilizing individual prediction methods which differ from each other.

In a possible example, information that indicates at least one of the first reference prediction region and the second reference prediction region has been multiplexed with the video code data.

In another possible example, information that indicates at least one prediction method utilized to set the first reference prediction region and the second reference prediction region has been multiplexed with the video code data.

In a typical example, the small regions are pixels.

The present invention also provides a video encoding method that divides each frame which forms an encoding target video into a plurality of processing regions, each processing region being subjected to predictive encoding, and generates a predicted image by utilizing a basic reference region associated with each processing region as an encoding target image, the method comprising:

a reference prediction region setting step that sets, for the encoding target image, a first reference prediction region and a second reference prediction region, which are reference regions associated with the basic reference region;

a weighting coefficient setting step that sets weighting coefficients assigned to individual small regions based on a first reference predicted image obtained by utilizing the first reference prediction region and a second reference predicted image obtained by utilizing the second reference prediction region;

a prediction region setting step that sets a first prediction region and a second prediction region, which are reference regions for the encoding target image; and

a predicted image generation step that generates, based on the weighting coefficients, the predicted image from a first primary-predicted image obtained by utilizing the first prediction region and a second primary-predicted image obtained by utilizing the second prediction region.

The present invention also provides a video decoding method that divides each decoding target frame which forms video code data into a plurality of processing regions, each processing region being subjected to decoding, and generates a predicted image by utilizing a basic reference region associated with each processing region as a decoding target image, the method comprising:

a reference prediction region setting step that sets, for the decoding target image, a first reference prediction region and a second reference prediction region, which are reference regions associated with the basic reference region;

a weighting coefficient setting step that sets weighting coefficients assigned to individual small regions based on a first reference predicted image obtained by utilizing the first reference prediction region and a second reference predicted image obtained by utilizing the second reference prediction region;

a prediction region setting step that sets a first prediction region and a second prediction region, which are reference regions for the decoding target image; and

a predicted image generation step that generates, based on the weighting coefficients, the predicted image from a first primary-predicted image obtained by utilizing the first prediction region and a second primary-predicted image obtained by utilizing the second prediction region.

The present invention also provides a video encoding program by which a computer executes the steps in the image encoding method.

The present invention also provides a video decoding program by which a computer executes the steps in the image decoding method.

### Effect of the Invention

According to the present invention, degradation in the prediction accuracy can be prevented by performing the weighted averaging for each small region in the bi-prediction, and thereby a highly accurate predicted image can be generated without encoding the weighting coefficients. Therefore, it is possible to reduce the amount of code required to encode the prediction residual.

### BRIEF DESCRIPTION OF THE DRAWINGS

FIG. 1 is a block diagram showing the structure of a video encoding apparatus according to a first embodiment of the present invention.

FIG. 2 is a flowchart showing the operation of the video encoding apparatus 100 shown in FIG. 1.

FIG. 3 is a block diagram that shows the structure of a video decoding apparatus according to the first embodiment.

FIG. 4 is a flowchart showing the operation of the video decoding apparatus 200 shown in FIG. 3.

FIG. 5 is a block diagram showing the structure of a video encoding apparatus according to a second embodiment of the present invention.

FIG. 6 is a flowchart showing the operation of the video encoding apparatus 100a shown in FIG. 5.

FIG. 7 is a block diagram that shows the structure of a video decoding apparatus according to the second embodiment.

FIG. 8 is a flowchart showing the operation of the video decoding apparatus 200a shown in FIG. 7.

FIG. 9 is a diagram showing a hardware configuration of the video encoding apparatus formed using a computer and a software program.

FIG. 10 is a diagram showing a hardware configuration of the video decoding apparatus formed using a computer and a software program.

### MODE FOR CARRYING OUT THE INVENTION

### First Embodiment

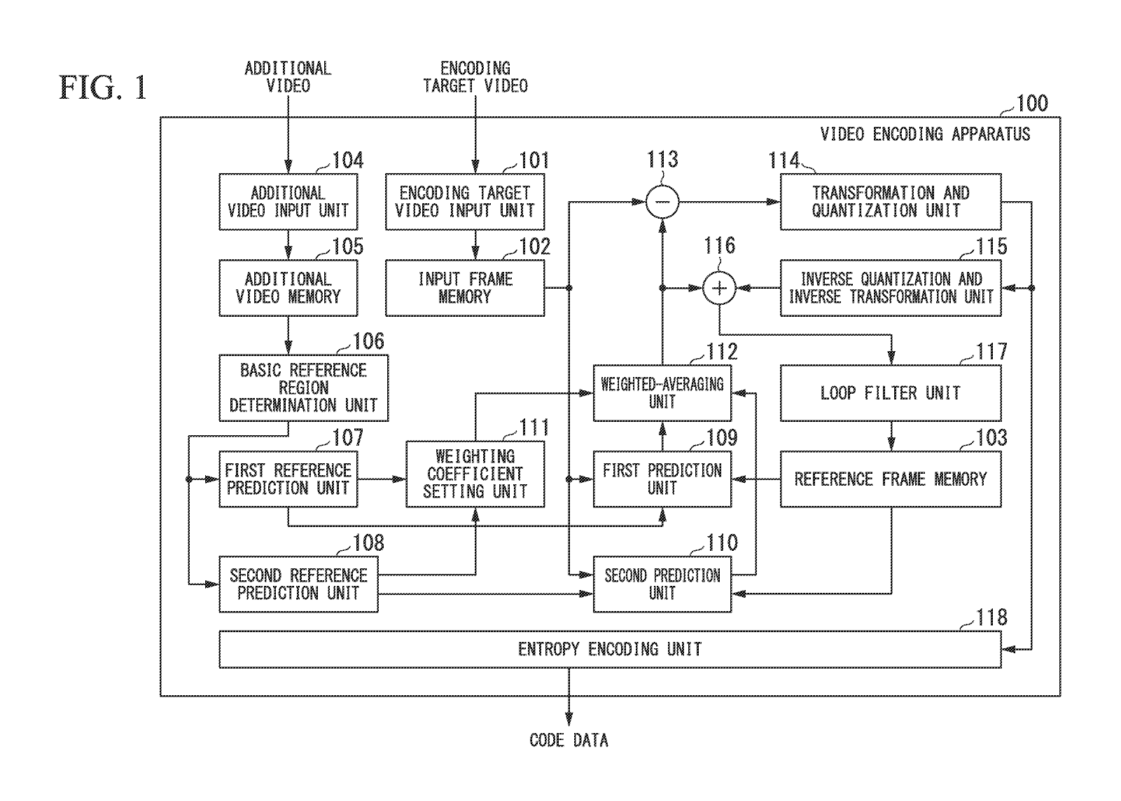

Below, a video encoding apparatus in accordance with a first embodiment of the present invention will be explained with reference to the drawings. FIG. 1 is a block diagram showing the structure of a video encoding apparatus 100 according to the present embodiment.

As shown in FIG. 1, the video encoding apparatus 100 includes an encoding target video input unit 101, an input frame memory 102, a reference frame memory 103, an additional video input unit 104, an additional video memory 105, a basic reference region determination unit 106, a first reference prediction unit 107, a second reference prediction unit 108, a first prediction unit 109, a second prediction unit 110, a weighting coefficient setting unit 111, a weighted-averaging unit 112, a subtraction unit 113, a transformation and quantization unit 114, an inverse quantization and inverse transformation unit 115, an addition unit 116, a loop filter unit 117, and an entropy encoding unit 118.

The encoding target video input unit 101 receives a video as an encoding target from an external device. Below, this video as an encoding target is called an “encoding target video”. In particular, a frame to be processed is called an “encoding target frame” or an “encoding target image”.

The input frame memory 102 stores the input encoding target video.

The reference frame memory 103 stores images which have been encoded and then decoded. Below, each stored image is called a “reference frame” or a “reference image”.

The additional video input unit 104 receives an additional video corresponding to the encoding target video from an external device. Below, this video is called an “additional video”. In particular, a frame that corresponds to the encoding target frame to be processed is called a “target additional frame” or a “target additional image”.

The additional video memory 105 stores the input additional video.

The basic reference region determination unit 106 determines a basic reference region on the additional image corresponding to the encoding target image.

The first reference prediction unit 107 and the second reference prediction unit 108 determine two or more reference prediction regions on the sored additional images, where the regions correspond to the basic reference region. The first reference prediction unit 107 and the second reference prediction unit 108 generate reference predicted images based on the individual reference prediction regions.

The first prediction unit 109 and the second prediction unit 110 determine two or more prediction regions on the sored reference images, where the regions correspond to the encoding target image. The first prediction unit 109 and the second prediction unit 110 generate primary-predicted images based on the individual prediction regions.

Based on the individual reference predicted images, the weighting coefficient setting unit 111 determines weighting coefficients for the primary-predicted images.

The weighted-averaging unit 112 multiplies the individual primary-predicted images by the set weighting coefficients and adds both products to generate a predicted image.

The subtraction unit 113 computes a difference between the encoding target image and the predicted image so as to generate a prediction residual.

The transformation and quantization unit 114 subjects the generated prediction residual to transformation and quantization to generate quantized data.

The inverse quantization and inverse transformation unit 115 subjects the generated quantized data to inverse quantization and inverse transformation so as to generate a decoded prediction residual.

The addition unit 116 generates a decoded image from the predicted image and the prediction residual.

The loop filter unit 117 multiplies the generated decoded image by a loop filter so as to generate a reference frame.

The entropy encoding unit 118 subjects the quantized data to entropy encoding so as to generate code (or encoded) data.

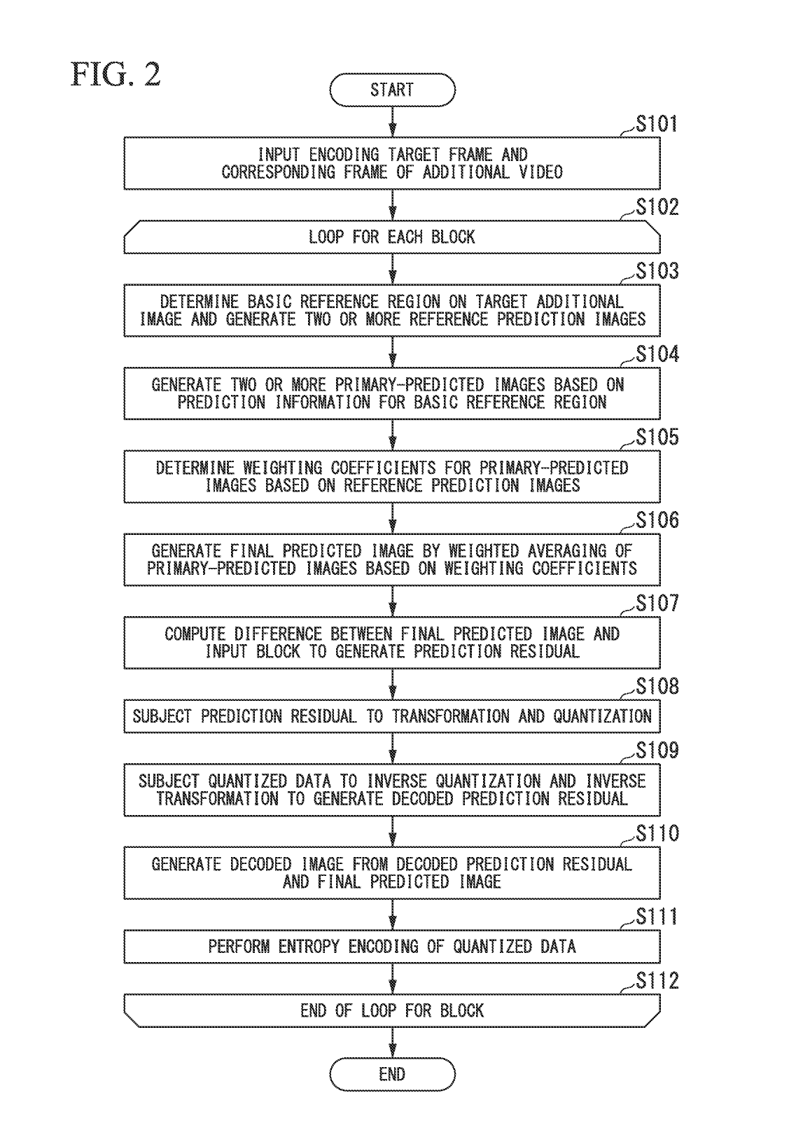

Next, the operation of the video encoding apparatus 100 shown in FIG. 1 will be explained with reference to FIG. 2. FIG. 2 is a flowchart showing the operation of the video encoding apparatus 100 shown in FIG. 1.

In the operation flow of FIG. 2, when prediction is performed on a corresponding region on a video (other than the encoding target) which correlates with the encoding target video, a prediction accuracy therefor is evaluated, and based on the prediction accuracy, a prediction accuracy measured when a similar prediction is performed on the encoding target video is evaluated. Through the evaluations, weighting coefficients utilized for the weighted averaging of the primary-predicted images are determined.

In the operation explained here, a frame of the encoding target video is encoded. The entire video can be encoded by repeating the explained operation.

First, the encoding target video input unit 101 receives the encoding target frame from an external device and stores the frame in the input frame memory 102. Similarly, the additional video input unit 104 receives the target additional frame in an additional video corresponding to the encoding target video from an external device and stores the frame in the additional video memory 105 (see step S101).

Here, some frames in the encoding target video have been previously encoded and decoded frames thereof are stored in the reference frame memory 103. In addition, the additional video memory 105 also stores additional frames corresponding to such decoded frames stored in the reference frame memory.

The received additional video is a video that differs from the encoding target video and correlates with the encoding target video. The additional video may be a video to be multiplexed with the encoding target video, and any video may be utilized if an equivalent video can be obtained in a corresponding decoding apparatus.

For example, a video from a viewpoint (for a multi-viewpoint video) other than that of the encoding target video may function as the additional video, or a video in a layer (for a scalable video) other than that of the encoding target video may also be utilized. If the encoding target video is an ordinary (camera) video, a depth map video for the camera video may be utilized, or a reverse relationship thereof is also possible. Any other video may be utilized as the additional video.

If the additional video is encoded and multiplexed with the encoding target video, it is preferable that an additional video which has been previously encoded and then decoded is input (as the additional video for the encoding target video) into the video encoding apparatus. However, this is not an absolute requirement.

After the video input, the encoding target frame is divided into encoding target blocks and each block is subjected to encoding of a video signal of the encoding target frame (see steps S102 to S112). The following steps S103 to S111 are repeatedly executed until all encoding target blocks of the relevant frame have been processed.

In the operation repeated for each block, first, the basic reference region determination unit 106 determines the basic reference region on the target additional image corresponding to the encoding target image.

Then the first reference prediction unit 107 and the second reference prediction unit 108 determine the reference prediction regions by performing prediction for the basic reference region on reference additional images stored in additional video memory 105. Based on the individual reference prediction regions, the first reference prediction unit 107 and the second reference prediction unit 108 generate a first reference predicted image and a second reference predicted image (see step S103).

The above reference prediction regions are regions referred to in the prediction of the basic reference region from the individual reference additional images, and obtained predicted images are the reference predicted images. If the inter prediction is employed, relevant corresponding regions are the reference prediction regions. If the intra prediction is employed, previously-encoded adjacent regions are the reference prediction regions.

The basic reference region may be determined by any method.

For example, if the additional video is a video from a different viewpoint for a multi-viewpoint video, a region corresponding to the encoding target image, which is obtained by disparity search, may be determined to be the basic reference region. When the additional video is a video in a layer (for a scalable video) other than that of the encoding target video, a region at the same location on the target additional image may be determined as a corresponding region, that is, the basic reference region. If the additional video is a depth map video for the original video or these videos have a reverse relationship thereof, a region at the same location on the target additional image may be determined to be the basic reference region.

In addition, information that indicates the basic reference region may be predetermined or may be estimated from prediction information for previously-encoded peripheral blocks, or the like. Such information that indicates the basic reference region may be multiplexed with the encoded video.

Preferably, the first reference prediction unit 107 and the second reference prediction unit 108 employ different prediction methods and/or different reference prediction regions.

Any method may be employed for determining the prediction methods, the reference additional images, and the reference prediction regions for the first reference prediction unit 107 and the second reference prediction unit 108 if a corresponding decoding apparatus can accurately determine such information items by using prediction information or the like and generate the reference predicted images.

Additionally, any combination between the prediction methods of the first reference prediction unit 107 and the second reference prediction unit 108 is possible. For example, both prediction units employ the inter prediction but refer to different pictures, or one prediction unit employs the inter prediction while the other prediction unit employs the inter prediction.

The prediction method and the reference additional images are not limited. They may be predetermined, or any information may be input together with the additional video. In another manner, they may be identical to those used in the encoding and decoding of the additional video or may be determined based on a result of any process (e.g., motion search) performed by the individual prediction units.

For example, it is predetermined that first reference prediction unit 107 performs forward prediction while the second reference prediction unit 108 performs backward prediction, or a certain criterion to determine the prediction method based on the frame number or other information may be predetermined.

Similarly, the reference prediction regions may be predetermined, or reference prediction information that indicates the reference prediction regions may be input together with the additional video. In addition, the reference prediction regions may be determined by utilizing prediction information or reference prediction information, which was utilized when a peripheral region or the additional video was encoded and then decoded. Additionally, the reference prediction regions may be estimated based on any method or determined based on a result of any process (e.g., motion search) performed by the individual prediction units.

If only the prediction methods are predetermined, the individual prediction units may each perform the prediction process by the predetermined prediction method so as to determine the prediction region. In this process, information such as a motion vector which indicates a region may be input and utilized. Such a motion vector may be determined based on a predetermined disparity or any additional information such as a depth map for the relevant video.

In addition, information that may indicate the prediction methods, the reference additional images, and the reference prediction regions may be encoded as reference prediction information, which may be multiplexed with the code data of the relevant video. Such encoding may be omitted if similar information can be obtained in a corresponding decoding apparatus.

For example, reference additional image IDs and reference motion vectors, which indicate the individual reference additional images and the individual reference prediction regions, may be encoded. However, instead of encoding such information items, they may be estimated in a corresponding decoding apparatus based on a previously-decoded peripheral block or the like. Any other estimation may be performed.

In another example, only information that indicates one of the reference prediction regions is encoded while information that indicates the other reference prediction region is predicted.

For example, if the first reference prediction unit 107 employs forward prediction from an I picture or a P picture while the second reference prediction unit 108 employs backward prediction from a P picture, then only a motion vector that indicates the second the reference prediction region is encoded and a motion vector that indicates the first the reference prediction region is predicted based on a motion vector which was used in the forward prediction of a peripheral block of the second reference prediction region.

For a multi-view video, if the first reference prediction unit 107 employs an inter-view prediction method while the second reference prediction unit 108 employs an inter prediction method, then only a reference motion vector that indicates the second the reference prediction region is encoded and a reference disparity vector that indicates the first the reference prediction region is predicted based on a disparity vector which was used in the inter-view prediction performed during the predictive encoding of a peripheral block of the second reference prediction region.

Any other combination or method may be employed.

In addition, only prediction information utilized in the prediction of the first prediction unit 109 and the second prediction unit 110 (explained later) may be subjected to the encoding and multiplexing, and a corresponding decoding apparatus may determine, based on the relevant prediction information, reference prediction information used in the first reference prediction unit 107 and the second reference prediction unit 108.

For example, if there is reference prediction information (reference image numbers or prediction vectors) determined by the first reference prediction unit 107 and the second reference prediction unit 108 during the encoding operation and the first prediction unit 109 and the second prediction unit 110 change and use this reference prediction information based on a certain corresponding relationship, then the prediction information changed by the first prediction unit 109 and the second prediction unit 110 is encoded and multiplexed with the code data. In the corresponding decoding apparatus, a reverse change is performed based on a corresponding relationship utilized to restore reference prediction information used in a first reference prediction unit and a second reference prediction unit (explained later) of the decoding apparatus. In this case, a first prediction unit and a second prediction unit (explained later) of the decoding apparatus can utilized decoded prediction information.

As described above, the prediction methods, the reference additional images, and the reference prediction regions for the first reference prediction unit 107 and the second reference prediction unit 108 may be determined by or to be any one or combination of relevant methods.

Next, the first prediction unit 109 and the second prediction unit 110 each perform a prediction process (similar to the process performed by the corresponding one of the first reference prediction unit 107 and the second reference prediction unit 108) on a reference image stored in the reference frame memory 103 to determine a reference region and generate a primary-predicted image (i.e., each unit generates one primary-predicted image) (see step S104).

The above reference region is a region to be referred to when the encoding target block is predicted by utilizing each reference image, and the predicted image obtained by this prediction is the primary-predicted image.

The prediction methods of the first prediction unit 109 and the second prediction unit 110 are equivalent to those employed by the first reference prediction unit 107 and the second reference prediction unit 108, and the reference images correspond to the reference predicted images. Such correspondence may be established by any corresponding relationship.

For example, as the reference images, reference images for the encoding target video, which have identical or corresponding frame numbers to those of the reference predicted images, may be employed. As the reference regions, regions having identical block numbers or identical locations to those of the reference prediction regions may be employed. If the additional video is a video from a viewpoint (for a multi-viewpoint video) other than that of the encoding target video, the relevant regions may be determined in consideration of disparity.

In addition, information which indicates such correspondence relationship may be encoded and multiplexed with the relevant video, and such encoding may be omitted if a corresponding decoding apparatus can estimate the information.

If prediction information utilized in the first prediction unit 109 and the second prediction unit 110 can be estimated based on such corresponding relationship and reference prediction information, encoding of relevant prediction information may be omitted and the prediction information may be estimated by a corresponding decoding apparatus.

For example, if prediction is performed by an identical prediction method which refers to an image having the same frame number, the reference image numbers and the predicted vectors utilized in the first prediction unit 109 and the second prediction unit 110 may be the same as those utilized in the first reference prediction unit 107 and the second reference prediction unit 108.

Additionally, the prediction information may be estimated by any other method based on a corresponding relationship and reference prediction information. If the reference prediction information is generated by utilizing the prediction information for the encoding of the additional video, encoding of both the prediction information and the reference prediction information may be omitted.

Next, the weighting coefficient setting unit 111 refers to the first reference predicted image and the second reference predicted image to determine a weighting coefficient assigned to each of small regions so as to perform weighted averaging between the first primary-predicted image and the second primary-predicted image (see step S105).

The small regions are regions having a unit area smaller than the encoding target region. The unit area may be predetermined or adaptively determined, or the pixels may functions as the small regions. In addition to the weighting coefficients, an offset coefficient may be determined and utilized.

The weighting coefficients may be determined by any method.

For example, It is assumed that an image at the basic reference region is generated when the first reference predicted image and the second reference predicted image are subjected to the weighted averaging based on the determined weighting coefficients. Then with given 1b which denotes the additional image for the basic reference region and Predb1 and Predb2 which respectively denote the first reference predicted image and the second reference predicted image, a weighting coefficient matrix w which minimizes the following formula is computed:

|1b−[w·Predb1+(1−w)·Predb2]|

The computation may be performed by any method. For example, a solution of a generally known an optimization problem may be employed, or an optimum one of predetermined weighting coefficient patterns may be selected. Any other method may also be employed, and information that indicates the employed method may be encoded and multiplexed with code data of the relevant video (i.e., video code data).

In another example, an image at the basic reference region is determined to be a basic reference image, and a first reference prediction residual and a second reference prediction residual may be generated (to be utilized) based on the basic reference image, the first reference predicted image, and the second reference predicted image. Any method can be employed to generate the first reference prediction residual and the second reference prediction residual.

For example, a method of simply subtracting a reference predicted image from the basic reference image to generate a reference prediction residual may be employed. An offset coefficient may also be applied, or any other process may be performed.

In addition, the content of such a method or process and necessary information therefor may be determined in any manner. They may be estimated based on prediction information that was used in the encoding of the additional information, or any other method can be utilized. Furthermore, information which indicates such a method or the like may be encoded and multiplexed with code data of the relevant video.

The weighting coefficients may be generated by any method. In a simplest method, if the weighting coefficients for the first primary-predicted image and the second primary-predicted image are respectively represented by W₁ and W₂ and the first reference prediction residual and the second reference prediction residual are respectively represented by ResPred1 and ResPred2, the following formula is computed:

W₁=|ResPred2|/(|ResPred1|+|ResPred2|)

W₂=|ResPred1|/(|ResPred1|+|ResPred2|)

In another method, the following formula may also be employed:

$${w}_{1} = \frac{1}{2} 〈 1 - sign ( \vert ResPred 1 \vert - \vert ResPred 2 \vert ) exp ( \frac{( \vert ResPred 1 \vert - {\vert ResPred 2 \vert}^{2} - 1 )}{2 {σ}^{2}} ) 〉 \qquad [ Formula 1 ]$$

Any other function for the reference prediction residual may be designed and utilized, and any other method may be employed to determine the weighting coefficients.

For example, optimum weighting coefficients are predetermined for a certain number of sets of the primary-predicted images, and correlation between the weighting coefficients and the reference prediction residual are learned in advance. In another example, a lookup table may be utilized, or any other method may be employed.

In addition, information that indicates such a method may be encoded and multiplexed with code data of the relevant video. Furthermore, information that indicates a method of determining the weighting coefficients may be encoded and multiplexed with code data of the relevant video.

In the above-described examples, only the weighting coefficients utilized to the multiplication for the individual primary-predicted images are determined. However, an offset coefficient may further be determined and the predicted images may be generated by further adding the offset coefficient to the relevant formula by the weighted-averaging unit explained later. The offset coefficient may be a scalar value or a coefficient matrix consisting of offset values assigned to the individual small regions. In addition, the offset coefficient may be determined in any manner.

If W₁ and W₂ denote the weighting coefficients, Pred1 and Pred2 denote the individual primary-predicted images, and D denotes an offset coefficient, the following formula may be computed:

Pred=[(W₁)(Pred1)]+[(W₂)(Pred2)]+D

The offset coefficient may be determined by any other method. Additionally, the offset coefficient may be determined simultaneously with the determination of the weighting coefficients, or they may be determined in turn.

Furthermore, the offset coefficient may be determined, not a coefficient itself, but another value. For example, a scaling coefficient for a predetermined offset coefficient may be determined Any other value may be employed, and the determination may be executed by any method.

Next, the weighted-averaging unit 112 generates a (final) predicted image from the first primary-predicted image and the second primary-predicted image based on the weighting coefficients (see step S106).

In this process, the predicted image may be generates by means of the weighted averaging between the primary-predicted images, and an offset coefficient may be further added.

Next, the subtraction unit 113 generates a prediction residual according to a difference between the predicted image and the encoding target image (see step S107).

The transformation and quantization unit 114 then subjects the prediction residual to transformation and quantization to generate quantized data (see step S108). The transformation and quantization may be performed by any method if the obtained data can be accurately inverse-quantized and inverse-transformed in a decoding process.

Next, the inverse quantization and inverse transformation unit 115 subjects the quantized data to inverse quantization and inverse transformation to generate a decoded prediction residual (see step S109).

The addition unit 116 adds the decoded prediction residual to the (final) predicted image so that a decoded image is generated (see step S110). Then the loop filter unit 117 multiplies the decoded image by a loop filter and stores the product as a reference frame in the reference frame memory 103.

The multiplication utilizing the loop filter may not be performed if it is not necessary. However, in general video encoding, encoding noises are removed utilizing a deblocking filter or another filter.

Next, the entropy encoding unit 118 subjects the quantized data to entropy encoding so as to generate code data (see step S111). If necessary, prediction information or other additional information may also be encoded and included in code data.

After all blocks are processed (see step S112), the code data is output.

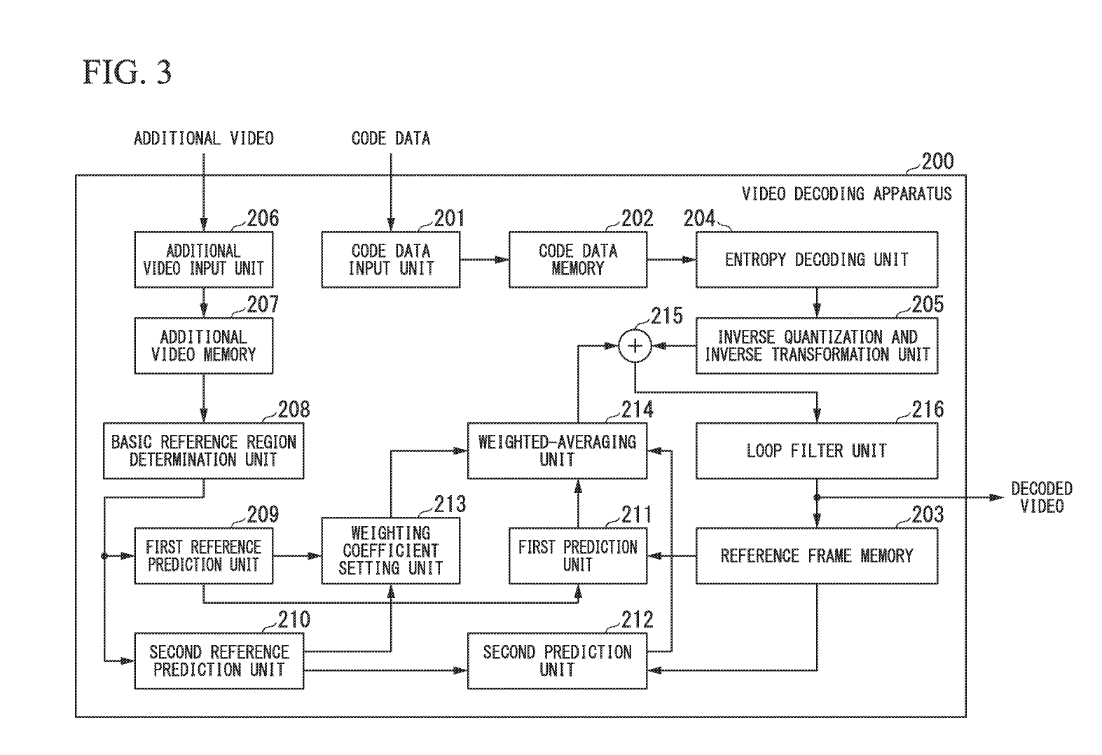

Below, a video decoding apparatus in the first embodiment will be explained. FIG. 3 is a block diagram that shows the structure of the video decoding apparatus.

As shown in FIG. 1, the video decoding apparatus 200 includes a code data input unit 201, a code data memory 202, a reference frame memory 203, an entropy decoding unit 204, an inverse quantization and inverse transformation unit 205, an additional video input unit 206, an additional video memory 207, a basic reference region determination unit 208, a first reference prediction unit 209, a second reference prediction unit 210, a first prediction unit 211, a second prediction unit 212, a weighting coefficient setting unit 213, a weighted-averaging unit 214, an addition unit 215, and a loop filter unit 216.

The code data input unit 201 receives video code data as a decoding target. Below, this video code data as a decoding target is called a “decoding target video code data”. In particular, a frame to be processed is called a “decoding target frame” or a “decoding target image”.

The code data memory 202 stores the input decoding target video.

The reference frame memory 203 stores images which have been previously decoded.

The entropy decoding unit 204 subjects the code data of the decoding target frame to entropy decoding, and the inverse quantization and inverse transformation unit 205 subjects the relevant quantized data to inverse quantization and inverse transformation so as to generate a decoded prediction residual.

The additional video input unit 206 receives an additional video corresponding to the decoding target video. Below, this video is called an “additional video”. In particular, a frame that corresponds to the decoding target frame to be processed is called a “target additional frame” or a “target additional image”.

The additional video memory 207 stores the input additional video.

The basic reference region determination unit 208 determines a basic reference region on the additional image corresponding to the decoding target image.

The first reference prediction unit 209 and the second reference prediction unit 210 determine two or more reference prediction regions on the sored additional images, where the regions correspond to the basic reference region. The first reference prediction unit 209 and the second reference prediction unit 210 generate reference predicted images based on the individual reference prediction regions.

The first prediction unit 211 and the second prediction unit 212 determine two or more prediction regions on the sored reference images, where the regions correspond to the decoding target image. The first prediction unit 211 and the second prediction unit 212 generate primary-predicted images based on the individual prediction regions.

Based on the individual reference predicted images, the weighting coefficient setting unit 213 determines weighting coefficients for the primary-predicted images.

The weighted-averaging unit 214 multiplies the individual primary-predicted images by the set weighting coefficients and adds both products to generate a predicted image.

The addition unit 215 generates a decoded image from the predicted image and the decoded prediction residual.

The loop filter unit 216 multiplies the generated decoded image by a loop filter so as to generate a reference frame.

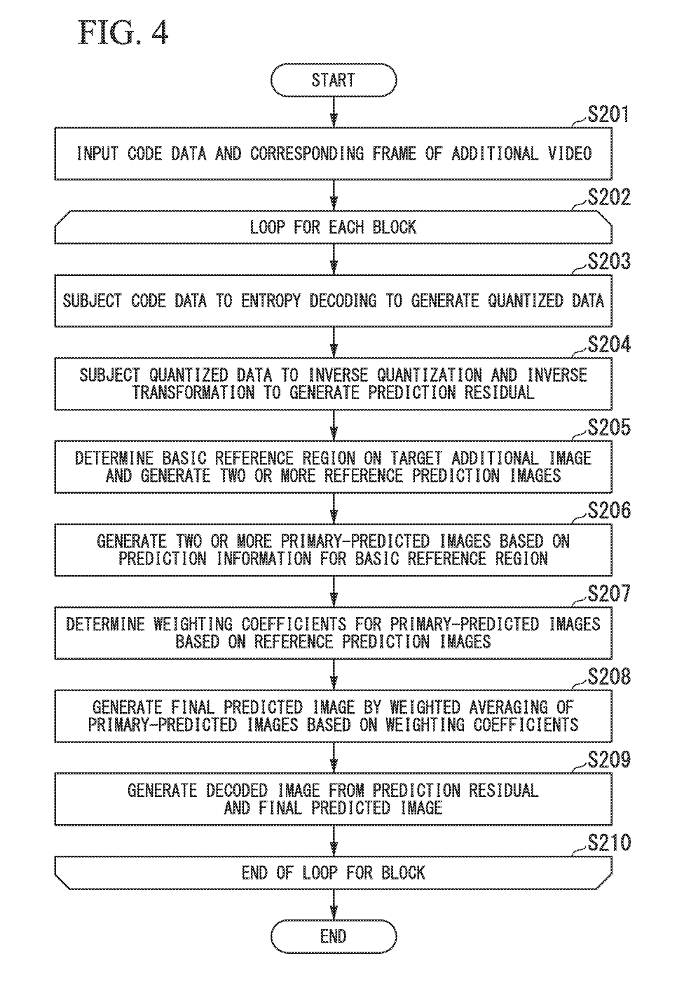

Next, the operation of the video decoding apparatus 200 shown in FIG. 3 will be explained with reference to FIG. 4. FIG. 4 is a flowchart showing the operation of the video decoding apparatus 200 shown in FIG. 3.

In the operation flow of FIG. 4, when prediction is performed on a corresponding region on a video (other than the decoding target) which correlates with the decoding target video, a prediction accuracy therefor is evaluated, and based on the prediction accuracy, a prediction accuracy measured when a similar prediction is performed on the decoding target video is evaluated. Through the evaluations, weighting coefficients utilized for the weighted averaging of the primary-predicted images are determined.

In the operation explained here, a frame in the coded data is decoded. The entire video can be decoded by repeating the explained operation.

First, the code data input unit 201 receives code data and stores the code data in the code data memory 202. The additional video input unit 206 receives a target addition frame of the additional video which corresponds to the encoding target video and stores the relevant frame in the additional video memory 207 (see step S201).

Here, some frames in the decoding target video have been previously decoded and are stored in the reference frame memory 203. In addition, the additional video memory 207 also stores additional frames that correspond to the decoded frames stored in the reference frame memory 203.

Next, the decoding target frame is divided into target blocks and each block is subjected to decoding of a video signal of the decoding target frame (see steps S202 to S210). That is, the following steps S203 to S209 are repeatedly executed until all decoding target blocks of the relevant frame have been processed.

In the operation repeated for each decoding target block, first, the entropy decoding unit 204 subjects the code data to entropy decoding so as to generate quantized data (see step S203). The inverse quantization and inverse transformation unit 205 subjects the quantized data to the inverse quantization and inverse transformation so as to generate a decoded prediction residual (see step S204).

If prediction information or other additional information is included in the code data, such information may also be decoded so as to appropriately generate required information.

Next, the basic reference region determination unit 208 determines the basic reference region on the target additional image corresponding to the decoding target image.

Then the first reference prediction unit 209 and the second reference prediction unit 210 determine the reference prediction regions by performing prediction for the basic reference region on reference additional images stored in additional video memory 207. Based on the individual reference prediction regions, the first reference prediction unit 107 and the second reference prediction unit 108 generate a first reference predicted image and a second reference predicted image (see step S205).

The basic reference region may be determined by any method if a region identical to that employed in the corresponding encoding can be set. Information that indicates the relevant region may be predetermined. If there is information which has been multiplexed with the relevant video, such information may be utilized. If information that indicates the relevant prediction methods or the reference prediction regions has been multiplexed with the code data for the video, such information may be utilized. However, such information may be omitted if the prediction can be performed in a manner similar to that of the encoding operation without using any specific prediction information. Detailed explanation for the basic reference region determination is similar to that of the above-described encoding operation.

Next, the first prediction unit 211 and the second prediction unit 212 each perform a prediction process (similar to the process performed by the corresponding one of the first reference prediction unit 209 and the second reference prediction unit 210) on a reference image stored in the reference frame memory 203 to determine a reference region and generate a primary-predicted image (i.e., each unit generates one primary-predicted image) (see step S206).

If information that indicates the relevant prediction methods or the prediction regions has been multiplexed with the code data for the video, such information may be utilized. However, such information may be omitted if the prediction can be performed in a manner similar to that of the encoding operation without using any specific prediction information. Detailed explanation for the basic reference region determination is similar to that of the above-described encoding operation, and thus a detailed explanation is omitted here.

Next, the weighting coefficient setting unit 213 refers to the first reference predicted image and the second reference predicted image to determine a weighting coefficient assigned to each of small regions so as to perform weighted averaging between the first primary-predicted image and the second primary-predicted image (see step S207).

The small regions are regions having a unit area smaller than the encoding target region. The unit area may be predetermined or adaptively determined, or the pixels may functions as the small regions. In addition to the weighting coefficients, an offset coefficient may be determined and utilized. If information that indicates the relevant method utilized to determine the weighting coefficients has been multiplexed with the code data for the video or the like, such information may be utilized. However, such information may be omitted if the weighting coefficients can be generated in a manner similar to that of the encoding operation without using any specific prediction information.

Next, the weighted-averaging unit 214 generates a (final) predicted image from the first primary-predicted image and the second primary-predicted image based on the weighting coefficients (see step S208). In this process, the predicted image may be generates by means of the weighted averaging between the primary-predicted images, and an offset coefficient may be further added.

Next, the addition unit 215 generates a decoded image by adding the predicted image to the decoded prediction residual (see step S209). Then the loop filter unit 216 multiplies the decoded image by a loop filter and stores the product as a reference frame in the reference frame memory 203.

The multiplication utilizing the loop filter may not be performed if it is not necessary. However, in general video coding (that includes decoding), encoding noises are removed utilizing a deblocking filter or another filter.

After all blocks are processed (see step S210), the processed frame is output as a decoded frame.

### Second Embodiment

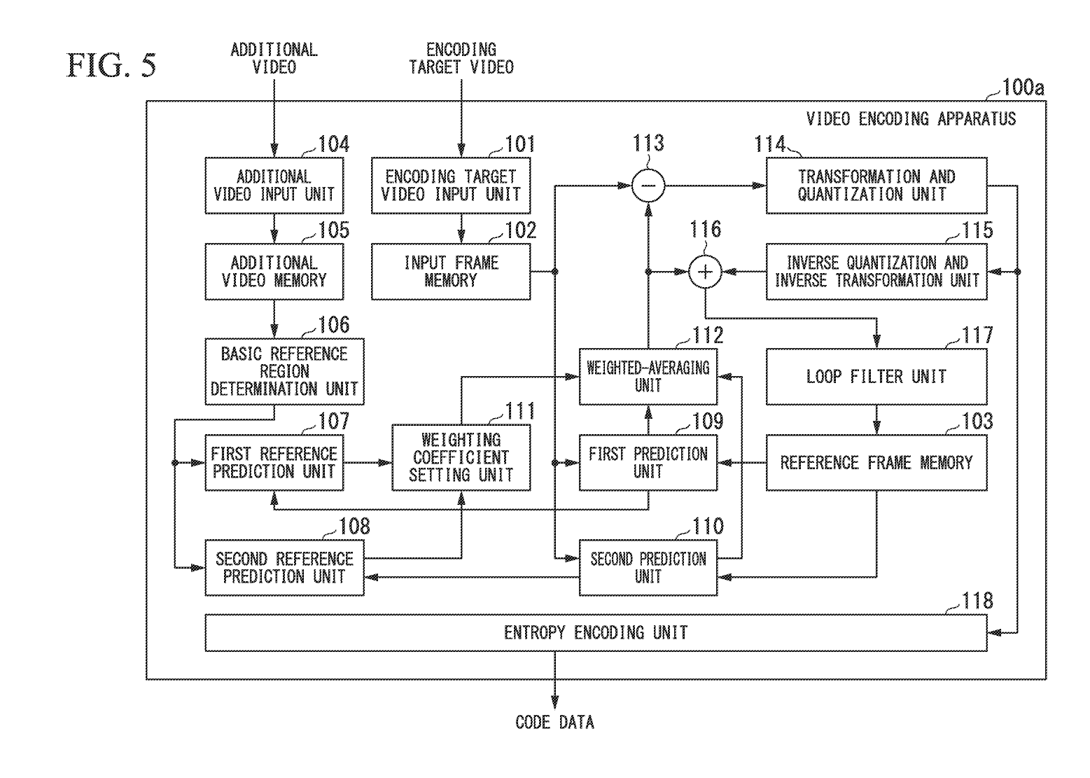

Below, a video encoding apparatus in accordance with a second embodiment of the present invention will be explained. FIG. 5 is a block diagram showing the structure of a video encoding apparatus 100a according to the present embodiment. In FIG. 5, parts identical to those in FIG. 1 are given identical reference numerals and explanations thereof are omitted here.

In comparison with the apparatus of FIG. 1 in which the signals output from the first reference prediction unit 107 and the second reference prediction unit 108 are input into the first prediction unit 109 and the second prediction unit 110, the apparatus of FIG. 5 has a distinctive feature such that the signals output from the first prediction unit 109 and the second prediction unit 110 are input into the first reference prediction unit 107 and the second reference prediction unit 108.

In FIG. 5, the first prediction unit 109 and the second prediction unit 110 determine two or more prediction regions on the sored reference images, where the regions correspond to the encoding target image. The first prediction unit 109 and the second prediction unit 110 generate predicted images based on the individual prediction regions.

The first reference prediction unit 107 and the second reference prediction unit 108 in FIG. 5 determine two or more reference prediction regions on the sored target additional image, where the regions correspond to the basic reference region. The first reference prediction unit 107 and the second reference prediction unit 108 generate reference predicted images based on the individual reference prediction regions.

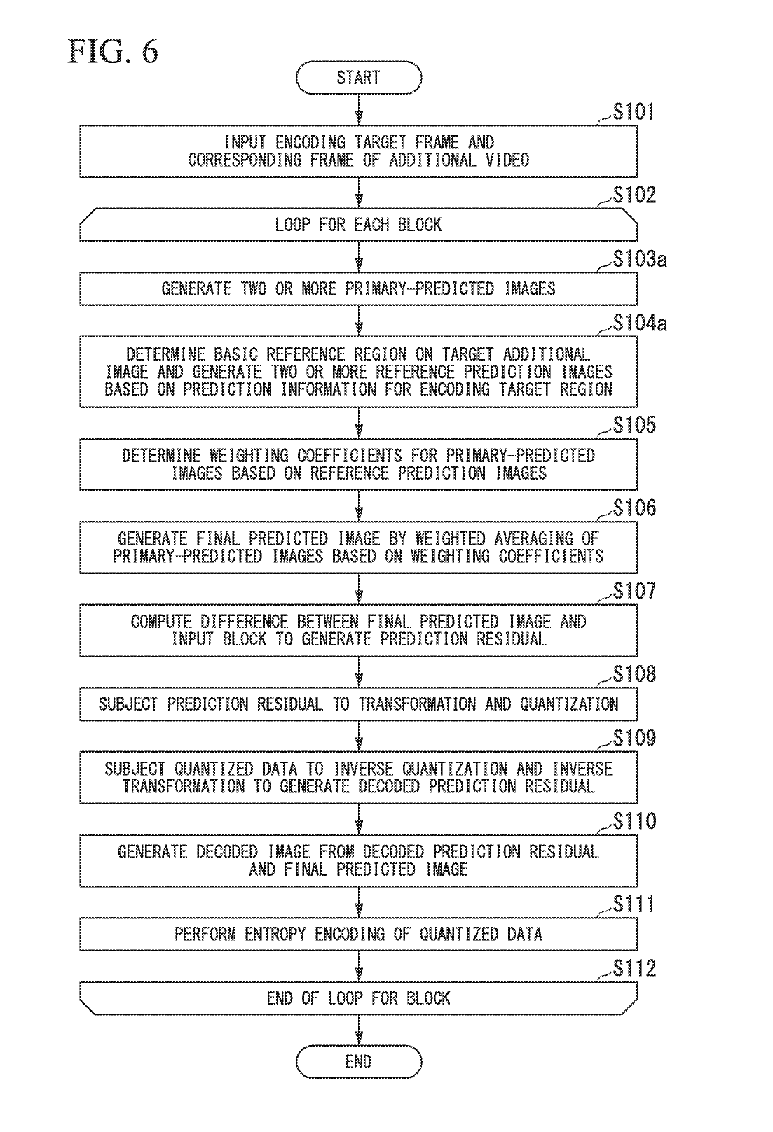

Next, the operation of the video encoding apparatus 100a shown in FIG. 5 will be explained with reference to FIG. 6. FIG. 6 is a flowchart showing the operation of the video encoding apparatus 100a shown in FIG. 5.

FIG. 6 especially shows a weighting coefficient setting process in which the reference predicted images with respect to the basic reference region are generated based on prediction information for the encoding target image and the generated reference predicted images are utilized to generates the weighting coefficients.

In FIG. 6, steps identical to those in FIG. 2 are given identical step numbers and explanations thereof are omitted here.

First, in steps S101 and S102, processes similar to the corresponding steps in the operation of FIG. 2 are performed.

Then the first prediction unit 109 and the second prediction unit 110 determine individual prediction regions by performing prediction for the encoding target image on the stored reference images. Based on the relevant prediction regions, the first prediction unit 109 and the second prediction unit 110 respectively generate a first primary-predicted image and a second primary-predicted image (see step S103a).

Any method may be employed for determining the prediction methods, the reference images, and the reference regions for the first prediction unit 109 and the second prediction unit 110 if a corresponding decoding apparatus can accurately determine such information items by using prediction information or the like and generate the primary-predicted images.

That is, the information items similar to those utilized for the reference prediction in the first embodiment may be employed, or different information items may be utilized. In addition, such information required for the prediction may be encoded as prediction information and multiplexed with code data of the relevant video.

Next, the first reference prediction unit 107 and the second reference prediction unit 108 each perform a prediction process (similar to the process performed by the corresponding one of the first prediction unit 109 and the second prediction unit 110) on a reference additional image stored in the additional video memory 105 to determine a reference prediction region and generate a primary-predicted image (i.e., each unit generates one reference predicted image) (see step S104a).

The prediction methods of the first reference prediction unit 107 and the second reference prediction unit 108 are equivalent to those employed by the first prediction unit 109 and the second prediction unit 110. Additionally, the reference predicted images correspond to the reference images, and the reference prediction regions correspond to the reference regions. Such correspondence may be established by any corresponding relationships. Detailed explanations are similar to those for the first embodiment.

The following steps S106 to S112 are executed in a manner similar to the corresponding steps in the flowchart of FIG. 2.

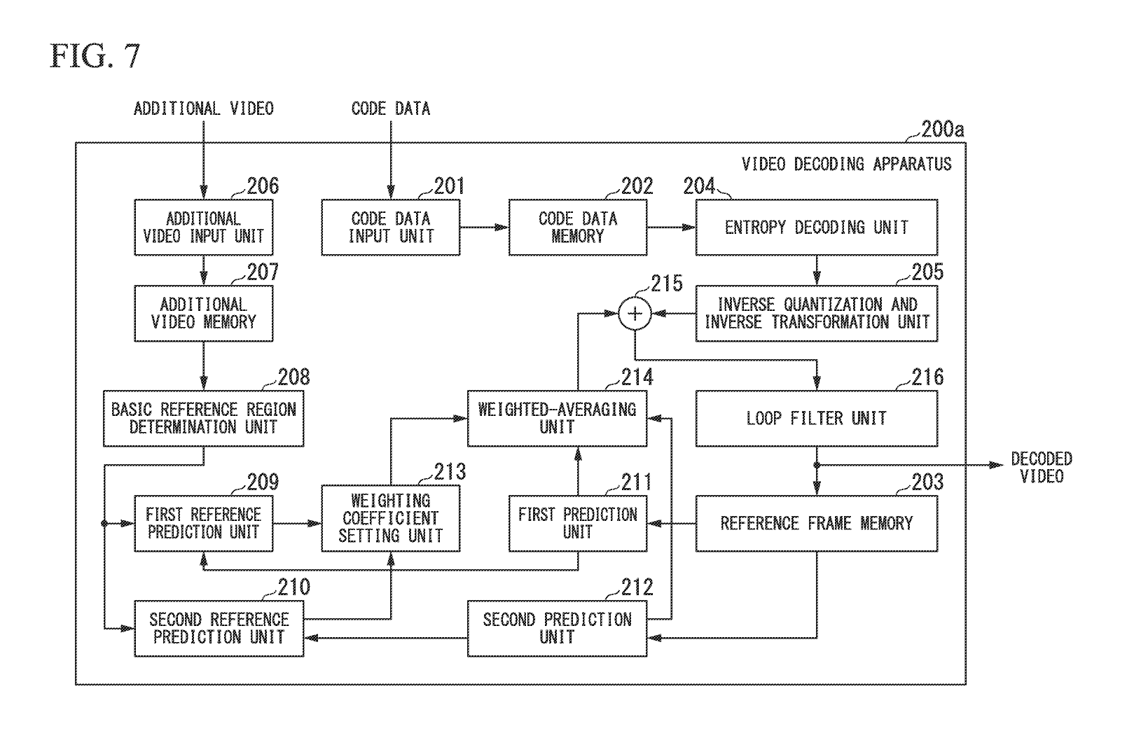

Below, a video decoding apparatus according to the second embodiment will be explained. FIG. 7 is a block diagram that shows the structure of the video decoding apparatus 200a according to the present embodiment. In FIG. 7, parts identical to those in FIG. 3 are given identical reference numerals and explanations thereof are omitted here.

In comparison with the apparatus of FIG. 3, the apparatus of FIG. 7 has distinctive features of further providing an auxiliary video input unit 210 and an auxiliary frame memory 211.

The auxiliary video input unit 210 is provided to input reference video, which is utilized in the decoded image updating, into the video decoding apparatus 200a. The auxiliary frame memory 211 stores the input auxiliary video.

In comparison with the apparatus of FIG. 3 in which the signals output from the first reference prediction unit 209 and the second reference prediction unit 210 are input into the first prediction unit 211 and the second prediction unit 212, the apparatus of FIG. 7 has a distinctive feature such that the signals output from the first prediction unit 211 and the second prediction unit 212 are input into the first reference prediction unit 209 and the second reference prediction unit 210.

In FIG. 7, the first prediction unit 211 and the second prediction unit 212 determine two or more prediction regions on the sored reference images, where the regions correspond to the decoding target image. The first prediction unit 211 and the second prediction unit 212 generate predicted images based on the individual prediction regions.

The first reference prediction unit 209 and the second reference prediction unit 210 in FIG. 7 determine two or more reference prediction regions on the sored target additional image, where the regions correspond to the basic reference region. The first reference prediction unit 209 and the second reference prediction unit 210 generate reference predicted images based on the individual reference prediction regions.

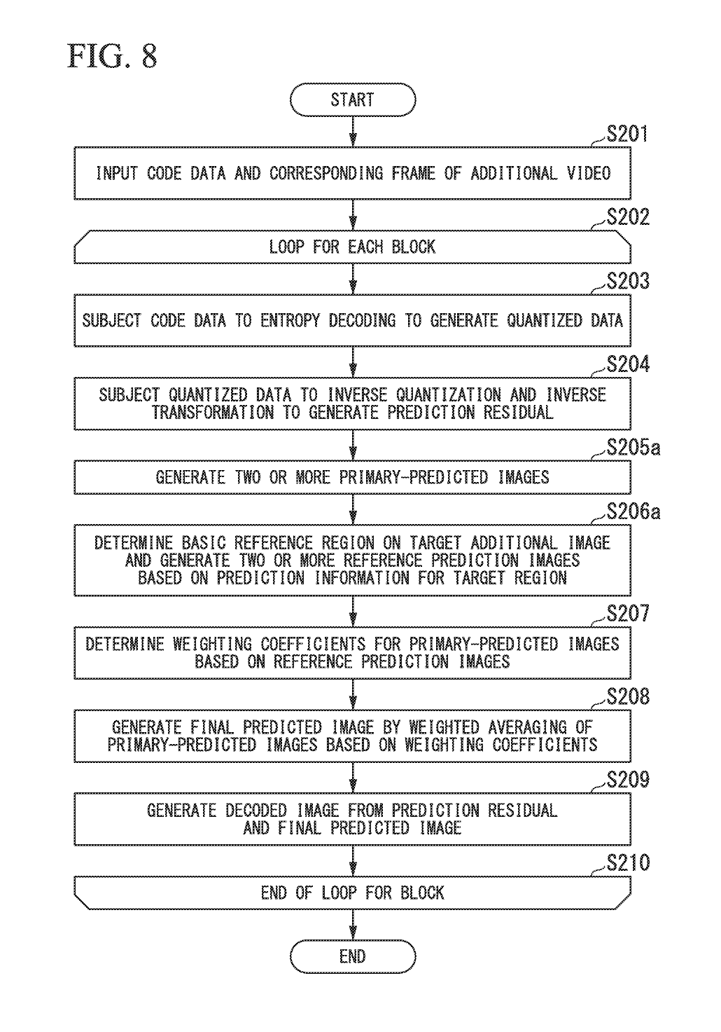

Next, the operation of the video decoding apparatus 200a shown in FIG. 7 will be explained with reference to FIG. 8. FIG. 8 is a flowchart showing the operation of the video decoding apparatus 200a shown in FIG. 7.

FIG. 8 especially shows a weighting coefficient setting process in which the reference predicted images with respect to the basic reference region are generated based on prediction information for the decoding target image and the generated reference predicted images are utilized to generates the weighting coefficients.

In FIG. 8, steps identical to those in FIG. 4 are given identical step numbers and explanations thereof are omitted here.

First, in steps S201 to S204, processes similar to the corresponding steps in the operation of FIG. 4 are performed.

Then the first prediction unit 211 and the second prediction unit 212 determine individual prediction regions by performing prediction for the target image on the stored reference images. Based on the relevant prediction regions, the first prediction unit 211 and the second prediction unit 212 respectively generate a first primary-predicted image and a second primary-predicted image (see step S205a).

Any method may be employed to determine the prediction methods, the reference images, and the reference regions for the first prediction unit 211 and the second prediction unit 212 if the primary-predicted images can be generated, similar to the above-described encoding operation.

That is, the information items similar to those utilized for the reference prediction in the first embodiment may be employed, or different information items may be utilized. In addition, if such information required for the prediction has been encoded and multiplexed with the video code data, the information may be utilized.

Next, the first reference prediction unit 209 and the second reference prediction unit 210 each perform a prediction process (similar to the process performed by the corresponding one of the first prediction unit 211 and the second prediction unit 212) on a reference additional image stored in the additional video memory 207 to determine a reference prediction region and generate a primary-predicted image (i.e., each unit generates one reference predicted image) (see step S206a).

The prediction methods of the first reference prediction unit 209 and the second reference prediction unit 210 are equivalent to those employed by the first prediction unit 211 and the second prediction unit 212. Additionally, the reference predicted images correspond to the reference images, and the reference prediction regions correspond to the reference regions. Such correspondence may be established by any corresponding relationships.

The following steps S207 to S210 are executed in a manner similar to the first embodiment.

In the above-described first and second embodiments, the weighting coefficients are applied to every block. However, the weighting coefficients may be applied to part of the blocks.

In addition, each block may have an individual combination between the prediction methods or the weighting coefficient determination methods for the first and second prediction units. In this case, information that indicates such a combination status may be encoded to be included in the additional information, or the decoding apparatus may have a function of determining propriety of adopting the relevant combination or determining the prediction method. In such a case, a trouble avoiding function or a correction function may be preferably added so as to prevent the decoding apparatus from being incapable of carrying out the decoding due to any encoding noise or transmission error.

In the general explanation of the first and second embodiments, common prediction information is utilized between the first and second reference prediction units and the first and second prediction units. However, the reference predicted images and the primary-predicted images may be generated in different prediction manners.

For example, the first and second prediction units perform the prediction by means of ordinary motion search on the encoding target video, and the first and second reference prediction units perform the prediction by means of motion search on a reference video. Any other combination may be employed.

In an example, the first and second prediction units perform the prediction by utilizing prediction information used when the additional video was encoded, and the first and second reference prediction units perform the prediction by any method. In another example, only part of information, such as the frame number to be referred to in the prediction, may be used in common.

The prediction information utilized in the individual prediction may be encoded and multiplexed with the video code data or may be estimated based on information about a peripheral block.

In the above-described first and second embodiments, the predicted image is generated by means of weighted averaging between the first and second primary-predicted images. However, the predicted image may be generated by means of weighted averaging of three or more primary-predicted images.

In this case, any number of basic reference regions or reference predicted images may be utilized, and any method of determining such items may be employed. A plurality of determination methods may be utilized as a combination.

Additionally, in the first and second embodiments, the basic reference region is set on the additional video other than the target video. However, the basic reference region may be set on a previously-decoded part of the same (target) video.

For example, when a fine texture or a repetitive pattern frequently appears in the relevant video, the basic reference region may be set on a frame which is identical to or different from the encoding target image in this video if the prediction error can be estimated based on a prediction residual obtained by such a setting. In any other case, the basic reference region can be set anywhere.

For example, when the inter prediction is performed with reference to a previously-decoded picture from a viewpoint (for a multi-viewpoint video) other than that of the encoding target video, the basic reference region may be set on a frame other than the encoding target frame in the encoding target video so that the obtained prediction residual is utilized to estimate the prediction error.

Furthermore, in the first and second embodiments, only one basic reference region is set. However, two or more basic reference regions may be set. In addition, the first and second reference prediction units may determine the individual reference regions based on different basic reference regions. In this case, the prediction region in the prediction of one of the units may be determined to be the basic reference region for the other unit. For example, if the prediction of one of the units is disparity-compensated prediction that refers to a previously-decoded picture of a video other than the encoding target video and the prediction of the other unit is motion-compensated prediction that refers to a previously-decoded picture of a frame other than the encoding target video, then the prediction region of the motion-compensated prediction may be utilized as the basic reference region by which the prediction error of the disparity-compensated prediction is estimated.

Although the first and second embodiments do not specifically distinguish luminance signals and color difference signals in the encoding target video from each other, they may be distinguished from each other.

For example, the color difference signal is encoded by utilizing fixed weighting coefficients, and in the encoding of the luminance signal, the weighting coefficients are determined with reference to prediction information or a prediction residual determined in the encoding of the color difference signal. A reverse handling thereof is also possible. In addition, different weighting coefficients may be applied to such signals.

Additionally, in part of the operations in the first and second embodiments, the execution order of the steps may be modified.

The above-described operations of each video encoding apparatus and each video decoding apparatus may be implemented using a computer and a software program, where the program may be provided by storing it in a computer-readable storage medium, or through a network.

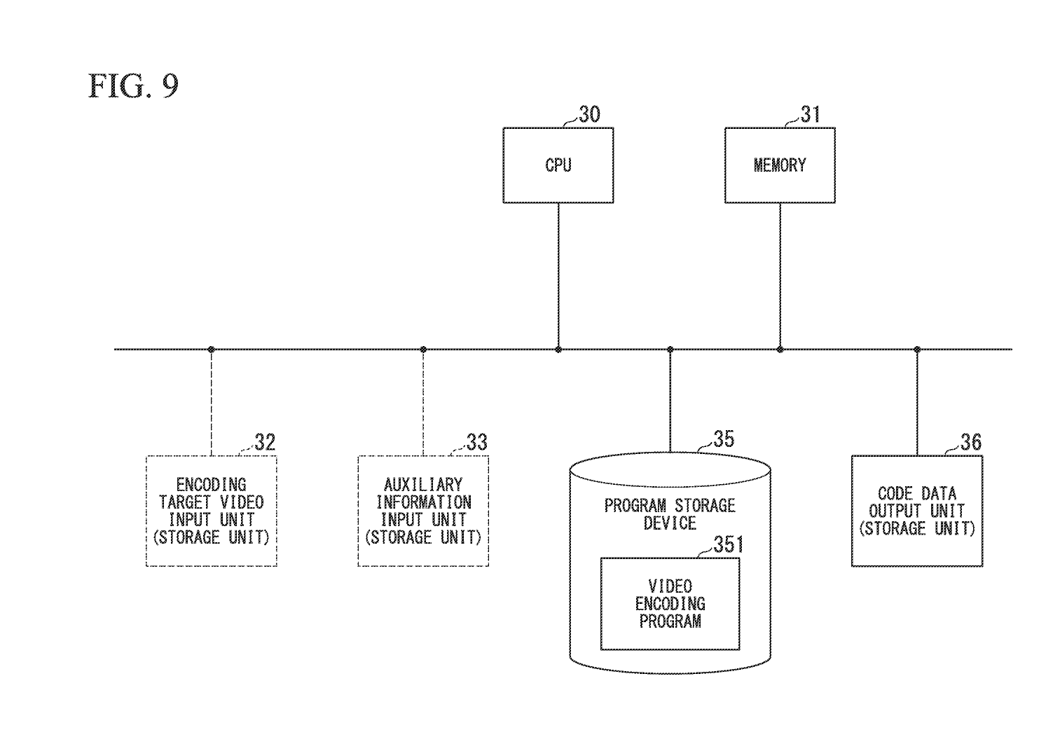

FIG. 9 shows an example of a hardware configuration of the video encoding apparatus formed using a computer and a software program.

In the relevant system, the following elements are connected via a bus:

(i) a CPU 30 that executes the relevant program;
(ii) a memory 31 (e.g., RAM) that stores the program and data accessed by the CPU 30;
(iii) an encoding target video input unit 32 that makes a video signal of an encoding target from a camera or the like input into the video encoding apparatus and may be a storage unit (e.g., disk device) which stores the video signal;
(iv) a program storage device 35 that stores a video encoding program 351 which is a software program for making the CPU 30 execute the operation explained with reference to the drawings such as FIGS. 2 and 6; and
(v) a code data output unit 36 that outputs coded data via a network or the like, where the coded data is generated by executing the video encoding program that is loaded on the memory 31 and executed by the CPU 30, and the output unit may be a storage unit (e.g., disk device) which stores the coded data.

In addition, if it is necessary to implement the encoding as explained in the first or second embodiment, the following unit may be further connected:

(vi) an auxiliary information input unit (storage unit) 33 that receives auxiliary information via a network or the like and may be a storage unit (e.g., disk device) which stores an auxiliary information signal.

Other hardware elements (not shown) are also provided so as to implement the relevant method, which are a code data storage unit, a reference frame storage unit, and the like. In addition, a video signal code data storage unit or a prediction information code data storage unit may be used.

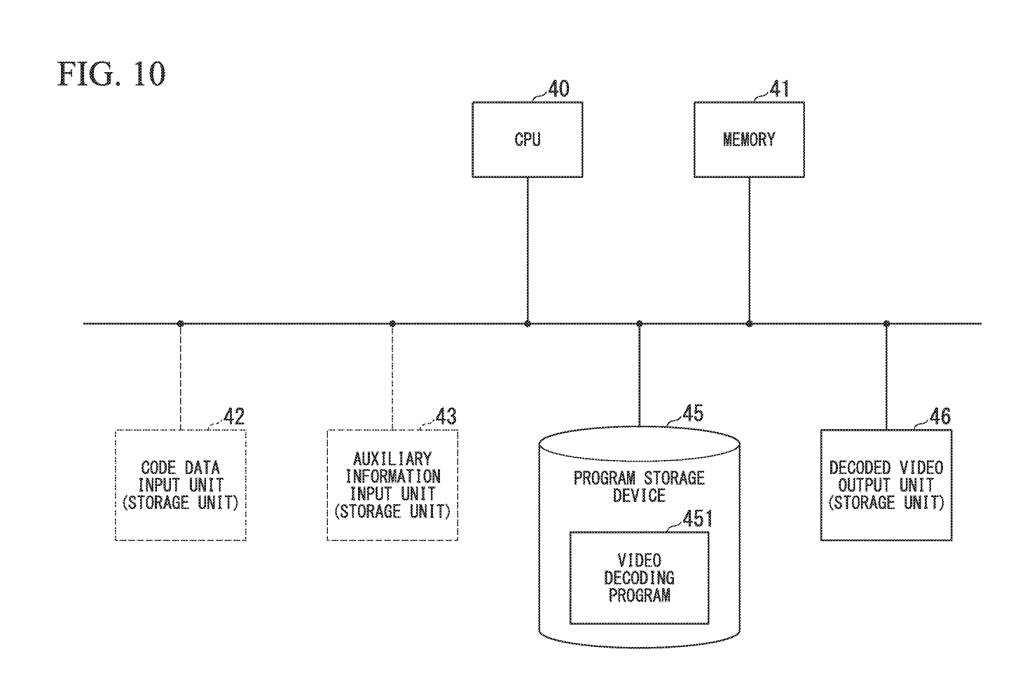

FIG. 10 shows an example of a hardware configuration of the video decoding apparatus formed using a computer and a software program.

In the relevant system, the following elements are connected via a bus:

(i) a CPU 40 that executes the relevant program;
(ii) a memory 41 (e.g., RAM) that stores the program and data accessed by the CPU 40;
(iii) a code data input unit 42 that makes code data obtained by a video encoding apparatus (which performs a method according to the present invention) input into the video decoding apparatus, where the input unit may be a storage unit (e.g., disk device) which stores the code data;
(iv) a program storage device 45 that stores a video decoding program 451 which is a software program for making the CPU 40 execute the operation explained with reference to the drawings such as FIGS. 4 and 8; and
(v) a decoded video data output unit 46 that outputs decoded video to a reproduction device or the like, where the decoded video is obtained by executing the video decoding program that is loaded on the memory 41 and executed by the CPU 40.

In addition, if it is necessary to implement the decoding as explained in the first or second embodiment, the following unit may be further connected:

(iv) an auxiliary information input unit (storage unit) 43 that receives auxiliary information via a network or the like and may be a storage unit (e.g., disk device) which stores an auxiliary information signal.

Other hardware elements (not shown) are also provided so as to implement the relevant method, which include a reference frame storage unit. In addition, a video signal code data storage unit or a prediction information code data storage unit may be used.

As explained above, for a prediction method (e.g., bi-prediction) which utilizes two or more predicted results, prediction accuracy is evaluated for a case when primary-predicted images as the predicted results are subjected to a prediction, that is similar to that for the encoding target video, in a corresponding region on the encoding target video or another video which correlates with the encoding target video. Based on the estimated result, the prediction accuracy for the encoding target video is evaluated so as to determine the weighting coefficients to be utilized in the weighted averaging of the primary-predicted images.

In this process, the prediction accuracy for each prediction is evaluated based on, for example:

(i) prediction information such as a predicted vector obtained when the above corresponding region was encoded, a predicted image (for the encoding) computed from such information, or a difference between such a predicted image and the image of the relevant region; or
(ii) a predicted image for the above corresponding region, which is generated by utilizing prediction information for the encoding target video, or a difference image between such a predicted image and the image of the relevant region.

According to the evaluated accuracy, the weighting coefficients are derived for each small region and the primary-predicted images are subjected to the weighted averaging, and thereby a highly accurate predicted image is generated without encoding the coefficient values.

Accordingly, degradation in the prediction accuracy can be prevented by performing the weighted averaging for each small region in the bi-prediction, and thereby a highly accurate predicted image can be generated without encoding the weighting coefficients. Therefore, it is possible to reduce the amount of code required to encode the prediction residual.

A program for executing the functions of the individual units in FIG. 1, 3, 5, or 7 may be stored in a computer readable storage medium, and the program stored in the storage medium may be loaded and executed on a computer system, so as to perform the relevant video encoding or decoding operation.

Here, the computer system has hardware resources which may include an OS and peripheral devices. The computer system also has a WWW system that provides a homepage service (or viewable) environment.

The above computer readable storage medium is a storage device, for example, a portable medium such as a flexible disk, a magneto optical disk, a ROM, or a CD-ROM, or a memory device such as a hard disk built in a computer system.

The computer readable storage medium also includes a device for temporarily storing the program, such as a volatile memory (RAM) in a computer system which functions as a server or client and receives the program via a network (e.g., the Internet) or a communication line (e.g., a telephone line).

The above program, stored in a memory device or the like of a computer system, may be transmitted via a transmission medium or by using transmitted waves passing through a transmission medium to another computer system. The transmission medium for transmitting the program has a function of transmitting data, and is, for example, a (communication) network such as the Internet or a communication line such (e.g., a telephone line).

In addition, the program may execute part of the above-explained functions.

The program may also be a “differential” program so that the above-described functions can be executed by a combination of the differential program and an existing program which has already been stored in the relevant computer system.

While the embodiments of the present invention have been described and shown above, it should be understood that these are exemplary embodiments of the invention and are not to be considered as limiting. Additions, omissions, substitutions, and other modifications can be made without departing from the technical concept and scope of the present invention.

### INDUSTRIAL APPLICABILITY

The present invention can be applied to a case for which it is preferable to generate a highly accurate predicted image without encoding coefficient values and to reduce the amount of code required to encode the prediction residual.

### REFERENCE SYMBOLS

100 video encoding apparatus
101 encoding target video input unit
102 input frame memory
103 reference frame memory
104 additional video input unit
105 additional video memory
106 basic reference region determination unit
107 first reference prediction unit
108 second reference prediction unit
109 first prediction unit
110 second prediction unit
111 weighting coefficient setting unit
112 weighted-averaging unit
113 subtraction unit
114 transformation and quantization unit
115 inverse quantization and inverse transformation unit
116 addition unit
117 loop filter unit
118 entropy encoding unit
200 video decoding apparatus
201 code data input unit
202 code data memory
203 reference frame memory
204 entropy decoding unit
205 inverse quantization and inverse transformation unit
206 additional video input unit
207 additional video memory
208 basic reference region determination unit
209 first reference prediction unit
210 second reference prediction unit
211 first prediction unit
212 second prediction unit
213 weighting coefficient setting unit
214 weighted-averaging unit
215 addition unit
216 loop filter unit

1. A video encoding apparatus that divides each frame which forms an encoding target video into a plurality of processing regions, each processing region being subjected to predictive encoding, and generates a predicted image by utilizing a basic reference region associated with each processing region as an encoding target image, the apparatus comprising:
a reference prediction region setting device that sets, for the encoding target image, a first reference prediction region and a second reference prediction region, which are reference regions associated with the basic reference region;
a weighting coefficient setting device that sets weighting coefficients assigned to individual small regions based on a first reference predicted image obtained by utilizing the first reference prediction region and a second reference predicted image obtained by utilizing the second reference prediction region;
a prediction region setting device that sets a first prediction region and a second prediction region, which are reference regions for the encoding target image; and
a predicted image generation device that generates, based on the weighting coefficients, the predicted image from a first primary-predicted image obtained by utilizing the first prediction region and a second primary-predicted image obtained by utilizing the second prediction region.

2. The video encoding apparatus in accordance with claim 1, wherein:
the first reference prediction region and the second reference prediction region are set based on prediction information utilized when the basic reference region was encoded.

3. The video encoding apparatus in accordance with claim 1, wherein:
the first prediction region and the second prediction region are set in a manner such that the first prediction region and the second prediction region have a relationship with the encoding target image, that is equivalent to a relationship which the first reference prediction region and the second reference prediction region have with the basic reference region.

4. The video encoding apparatus in accordance with claim 1, wherein:
the first reference prediction region and the second reference prediction region are set in a manner such that the first reference prediction region and the second reference prediction region have a relationship with the basic reference region, that is equivalent to a relationship which the first prediction region and the second prediction region have with the encoding target image.

5. A video decoding apparatus that divides each decoding target frame which forms video code data into a plurality of processing regions, each processing region being subjected to decoding, and generates a predicted image by utilizing a basic reference region associated with each processing region as a decoding target image, the apparatus comprising:
a reference prediction region setting device that sets, for the decoding target image, a first reference prediction region and a second reference prediction region, which are reference regions associated with the basic reference region;
a weighting coefficient setting device that sets weighting coefficients assigned to individual small regions based on a first reference predicted image obtained by utilizing the first reference prediction region and a second reference predicted image obtained by utilizing the second reference prediction region;
a prediction region setting device that sets a first prediction region and a second prediction region, which are reference regions for the decoding target image; and
a predicted image generation device that generates, based on the weighting coefficients, the predicted image from a first primary-predicted image obtained by utilizing the first prediction region and a second primary-predicted image obtained by utilizing the second prediction region.

6. The video decoding apparatus in accordance with claim 5, wherein:
the first reference prediction region and the second reference prediction region are set based on prediction information utilized when the basic reference region was decoded.

7. The video decoding apparatus in accordance with claim 5, wherein:
the first prediction region and the second prediction region are set in a manner such that the first prediction region and the second prediction region have a relationship with the decoding target image, that is equivalent to a relationship which the first reference prediction region and the second reference prediction region have with the basic reference region.

8. The video decoding apparatus in accordance with claim 5, wherein:
the first reference prediction region and the second reference prediction region are set in a manner such that the first reference prediction region and the second reference prediction region have a relationship with the basic reference region, that is equivalent to a relationship which the first prediction region and the second prediction region have with the decoding target image.

9. The video decoding apparatus in accordance with claim 5, further comprising:
a reference prediction residual generation device that generates a first reference prediction residual and a second reference prediction residual by computing:
a difference between a basic reference image set based on the basic reference region and the first reference predicted image obtained by utilizing the first reference prediction region; and
a difference between the basic reference image and the second reference predicted image obtained by utilizing the second reference prediction region,
wherein the weighting coefficient setting device sets the weighting coefficients based on the first reference prediction residual and the second reference prediction residual.

10. The video decoding apparatus in accordance with claim 5, wherein:
the basic reference region is set on an image obtained by a camera that differs from a camera by which the decoding target image was obtained.

11. The video decoding apparatus in accordance with claim 5, wherein:
when a decoding target of the video code data is a depth video, the basic reference region is set on an image of a camera video that corresponds to the depth video.

12. The video decoding apparatus in accordance with claim 5, wherein:
the first reference prediction region and the second reference prediction region are set by utilizing individual prediction methods which differ from each other.

13. The video decoding apparatus in accordance with claim 5, wherein:
information that indicates at least one of the first reference prediction region and the second reference prediction region has been multiplexed with the video code data.

14. The video decoding apparatus in accordance with claim 5, wherein:
information that indicates at least one prediction method utilized to set the first reference prediction region and the second reference prediction region has been multiplexed with the video code data.

15. The video decoding apparatus in accordance with claim 5, wherein:
the small regions are pixels.

16. A video encoding method that divides each frame which forms an encoding target video into a plurality of processing regions, each processing region being subjected to predictive encoding, and generates a predicted image by utilizing a basic reference region associated with each processing region as an encoding target image, the method comprising:
a reference prediction region setting step that sets, for the encoding target image, a first reference prediction region and a second reference prediction region, which are reference regions associated with the basic reference region;
a weighting coefficient setting step that sets weighting coefficients assigned to individual small regions based on a first reference predicted image obtained by utilizing the first reference prediction region and a second reference predicted image obtained by utilizing the second reference prediction region;
a prediction region setting step that sets a first prediction region and a second prediction region, which are reference regions for the encoding target image; and
a predicted image generation step that generates, based on the weighting coefficients, the predicted image from a first primary-predicted image obtained by utilizing the first prediction region and a second primary-predicted image obtained by utilizing the second prediction region.

17. A video decoding method that divides each decoding target frame which forms video code data into a plurality of processing regions, each processing region being subjected to decoding, and generates a predicted image by utilizing a basic reference region associated with each processing region as a decoding target image, the method comprising:
a reference prediction region setting step that sets, for the decoding target image, a first reference prediction region and a second reference prediction region, which are reference regions associated with the basic reference region;
a weighting coefficient setting step that sets weighting coefficients assigned to individual small regions based on a first reference predicted image obtained by utilizing the first reference prediction region and a second reference predicted image obtained by utilizing the second reference prediction region;
a prediction region setting step that sets a first prediction region and a second prediction region, which are reference regions for the decoding target image; and
a predicted image generation step that generates, based on the weighting coefficients, the predicted image from a first primary-predicted image obtained by utilizing the first prediction region and a second primary-predicted image obtained by utilizing the second prediction region.

18. A video encoding program by which a computer executes the steps in the image encoding method in accordance with claim 16.

19. A video decoding program by which a computer executes the steps in the image decoding method in accordance with claim 17.
